(19) United States
(12) Patent Application Publication
(10) Pub. No.: US 2023/0164767 A1
(43) Pub. Date: May 25, 2023

(54) OPERATING METHODS OF BASE STATION AND USER EQUIPMENT IN COMMUNICATION SYSTEM AND USER EQUIPMENT

(71) Applicant: ELECTRONICS AND TELECOMMUNICATIONS RESEARCH INSTITUTE, Daejeon (KR)

(72) Inventors: Ji Soo PARK, Daejeon (KR); NAM IL KIM, Daejeon (KR); Moon Sik LEE, Daejeon (KR)

(73) Assignee: ELECTRONICS AND TELECOMMUNICATIONS RESEARCH INSTITUTE, Daejeon (KR)

(21) Appl. No.: 17/992,537

(22) Filed: Nov. 22, 2022

(30) Foreign Application Priority Data
Nov. 23, 2021 (KR) 10-2021-0162403
Oct. 18, 2022 (KR) 10-2022-0133869

(51) Int. Cl. H04W 72/12; H04L 1/00

(52) U.S. Cl. CPC H04W 72/121; H04W 72/1263; H04W 72/1278; H04L 1/0003; H04W 72/1226

(57) ABSTRACT

An operating method of a base station in a communication system may comprise: providing group resource control (GRC) configuration information including at least one piece of group resource control assignment (GRCA) set information including at least one piece of GRCA information to at least one piece of user equipment (UE) belonging to a UE group; providing GRCA activation control information including one or more pieces of activated GRCA information selected from a GRCA set and one or more pieces of group scheduling indicator (GSI) information indicating the selected one or more pieces of activated GRCA information to the at least one UE; and providing group scheduling information including at least one piece of GSI information selected from the one or more pieces of GSI information to the at least one UE.

### CROSS-REFERENCE TO RELATED APPLICATIONS

This application claims priority to Korean Patent Applications No. 10-2021-0162403, filed on Nov. 23, 2021, and No. 10-2022-0133869, filed on Oct. 18, 2022, with the Korean Intellectual Property Office (KIPO), the entire contents of which are hereby incorporated by reference.

### BACKGROUND

### 1. Technical Field

Example embodiments of the present disclosure relate in general to a group scheduling technology in a communication system and, more specifically, to a group scheduling technology in a communication system for scheduling a group of one or more user equipments (UEs).

### 2. Related Art

With the development of information and communication technologies, various wireless communication technologies are being developed. As the representative wireless communication technologies, there may be long term evolution (LTE), new radio (NR), or the like defined as the 3rd generation partnership project (3GPP) specifications. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Communication systems may control radio resources in accordance with a system environment such a wireless channel state and the like of a UE. It may be necessary to continuously improve a method and procedure for scheduling downlink and uplink data in accordance with a state of a wireless channel.

### SUMMARY

Accordingly, example embodiments of the present disclosure are provided to substantially obviate one or more problems due to limitations and disadvantages of the related art.

Example embodiments of the present disclosure provide a group scheduling method and device in a communication system for making radio resource groups for a group of one or more user equipments (UEs) in various ways and scheduling the UEs included in the group using grouped radio resources.

According to a first exemplary embodiment of the present disclosure, an operating method of a base station in a communication system may comprise: providing group resource control (GRC) configuration information including at least one piece of group resource control assignment (GRCA) set information including at least one piece of GRCA information to at least one piece of user equipment (UE) belonging to a UE group; providing GRCA activation control information including one or more pieces of activated GRCA information selected from a GRCA set and one or more pieces of group scheduling indicator (GSI) information indicating the selected one or more pieces of activated GRCA information to the at least one UE; and providing group scheduling information including at least one piece of GSI information selected from the one or more pieces of GSI information to the at least one UE.

The providing of the GRC configuration information to the at least one UE belonging to the UE group may comprise: generating the at least one piece of GRCA information including group scheduling resource (GSR) information; generating the at least one piece of GRCA set information including the at least one piece of GRCA information; generating the GRC configuration information including the at least one piece of GRCA set information; and providing the GRC configuration information to the at least one UE belonging to the UE group, wherein the GSR information includes at least one of modulation and coding scheme (MCS) information necessary for scheduling, resource assignment information of time and frequency domains, and resource mapping information.

The operating method may further comprise receiving a report signal from the at least one UE, wherein the one or more pieces of activated GRCA information selected from the GRCA set are formed on the basis of the report signal, or the at least one piece of GSI information selected from the one or more pieces of GSI information is formed on the basis of the report signal, and the report signal includes at least one of beam measurement information (BMI), channel state information (CSI), and data buffer state information (BSI).

The providing of the GRCA activation control information to the at least one UE may comprise: activating any one GRCA set in the GRC configuration information; generating the selected one or more pieces of activated GRCA information from the activated GRCA set; generating the GRCA activation control information including the selected one or more pieces of activated GRCA information and the one or more pieces of GSI information indicating the selected one or more pieces of activated GRCA information; and providing the GRCA activation control information to the at least one UE belonging to the UE group.

The operating method may further comprise giving a group scheduling radio network temporary identifier (GS-RNTI) to the UE group, wherein the GRC configuration information including the GS-RNTI is transmitted to the at least one UE, and the group scheduling information is transmitted to the at least one UE through control information which is scrambled using the GS-RNTI.

The providing of the group scheduling information to the at least one UE may comprise: selecting the at least one piece of GSI information from the one or more pieces of GSI information; generating the group scheduling information including the selected at least one piece of GSI information; and providing the generated group scheduling information to the at least one UE.

The group scheduling information may be downlink group scheduling information, and the operating method may further comprise: generating downlink data; transmitting the downlink data to the at least one UE in accordance with the downlink group scheduling information; and receiving hybrid automatic repeat and request acknowledgement (HARQ-ACK) feedback for the downlink data.

The group scheduling information may be uplink group scheduling information, and the operating method may further comprise receiving uplink data from the at least one UE in accordance with the group scheduling information.

According to a second exemplary embodiment of the present disclosure, an operating method of a user equipment (UE) in a communication system may comprise: receiving group resource control (GRC) configuration information including at least one piece of group resource control assignment (GRCA) set information including at least one piece of GRCA information from a base station; receiving GRCA activation control information including one or more pieces of activated GRCA information selected from a GRCA set and one or more pieces of group scheduling indicator (GSI) information indicating the selected one or more pieces of activated GRCA information from the base station; and receiving group scheduling information including any one piece of GSI information selected from the one or more pieces of GSI information from the base station.

The GRCA information may include group scheduling resource (GSR) information, wherein the GSR information includes at least one of modulation and coding scheme (MCS) information necessary for scheduling, resource assignment information of time and frequency domains, and resource mapping information.

The GRCA activation control information received from the base station may include at least one of activation or deactivation indication information, serving cell identifier (ID) information, bandwidth part (BWP) ID information, GRCA set ID information, activated GRCA number information, and group scheduling resource (GSR) information.

The GRC configuration information may include a group scheduling radio network temporary identifier (GS-RNTI) for a UE group, and the group scheduling information may be received through control information which is scrambled using the GS-RNTI.

The operating method may further comprise: acquiring any one piece of GSI information from the group scheduling information; specifying GSI information corresponding to the UE in the acquired GSI information with reference to the GRCA activation control information; and acquiring GRCA information corresponding to the UE in accordance with the specified GSI information with reference to the GRC configuration information.

The operating method may further comprise: checking group scheduling resource (GSR) information of the GRCA information corresponding to the UE; and when the group scheduling information is downlink group scheduling information, receiving downlink data on the basis of the checked GSR information.

The operating method may further comprise: checking group scheduling resource (GSR) information of the GRCA information corresponding to the UE; when the group scheduling information is uplink group scheduling information, preparing uplink data; and transmitting the prepared uplink data to the base station on the basis of the checked GSR information.

The operating method may further comprise transmitting a report signal including at least one of beam measurement information (BMI), channel state information (CSI), and data buffer state information (BSI) to the base station, wherein the one or more pieces of activated GRCA information selected from the GRCA set are generated on the basis of the report signal, or the one piece of GSI information selected from the one or more pieces of GSI information is generated on the basis of the report signal.

According to a third exemplary embodiment of the present disclosure, a user equipment (UE) may comprise a processor, wherein the processor may operate to cause the UE to perform operations of: receiving group resource control (GRC) configuration information including at least one piece of group resource control assignment (GRCA) set information including at least one piece of GRCA information from a base station; receiving GRCA activation control information including one or more pieces of activated GRCA information selected from a GRCA set and one or more pieces of group scheduling indicator (GSI) information indicating the selected one or more pieces of activated GRCA information from the base station; and receiving group scheduling information including any one piece of GSI information selected from the one or more pieces of GSI information from the base station.

The GRC configuration information may include a group scheduling radio network temporary identifier (GS-RNTI) for a UE group, and the group scheduling information may be received through control information which is scrambled using the GS-RNTI.

The processor may operate to cause the UE to further perform operations of: acquiring any one piece of GSI information from the group scheduling information; specifying GSI information corresponding to the UE in the acquired GSI information with reference to the GRCA activation control information; and acquiring GRCA information corresponding to the UE in accordance with the specified GSI information with reference to the GRC configuration information.

The processor may operate to cause the UE to further perform operations of: checking group scheduling resource (GSR) information of the GRCA information corresponding to the UE; and when the group scheduling information is downlink group scheduling information, receiving downlink data on the basis of the checked GSR information.

According to the present application, in a wireless communication system of an environment in which UEs are highly concentrated, a base station can make resource groups of radio resources for a UE group of one or more UEs in various ways. Also, according to the present application, it is possible to activate or deactivate resources in a resource group in accordance with a wireless channel state of a UE in a UE group or movement of the UE.

Further, according to the present application, a base station can provide group scheduling to UEs in a UE group for uplink or downlink scheduling in accordance with a wireless channel state or various other types of information. Also, according to the present application, a base station can provide scheduling information to UEs using one DCI. Accordingly, radio resources required for transmitting control information can be reduced, and thus system performance can be improved.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram showing a first example embodiment of group resource control (GRC) configuration information.

FIG. 4 is a conceptual diagram showing a first example embodiment of GRCA activation control information.

FIG. 5 is a conceptual diagram showing a first example embodiment of group scheduling information.

FIG. 6 is a sequence diagram illustrating a first example embodiment of a group scheduling method in a communication system.

FIG. 7 is a conceptual diagram showing a first example embodiment of GRC configuration information for a UE.

FIG. 8 is a conceptual diagram showing a second example embodiment of GRC configuration information for UE.

FIG. 9 is a conceptual diagram showing a third example embodiment of GRC configuration information for UE.

FIG. 10 is a conceptual diagram showing a first example embodiment of GRCA activation control information for a UE.

FIG. 11 is a conceptual diagram showing a second example embodiment of GRCA activation control information for a UE.

FIG. 12 is a conceptual diagram showing a third example embodiment of GRCA activation control information for a UE.

FIG. 13 is a conceptual diagram showing a first example embodiment of a process of generating downlink group scheduling information.

FIG. 14 is a sequence diagram illustrating a second example embodiment of a group scheduling method in a communication system.

FIG. 15 is a conceptual diagram showing a first example embodiment of a process of generating uplink group scheduling information.

FIG. 16 is a conceptual diagram showing a first example embodiment of a process in which a UE receives group scheduling information and transmits and receives data.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

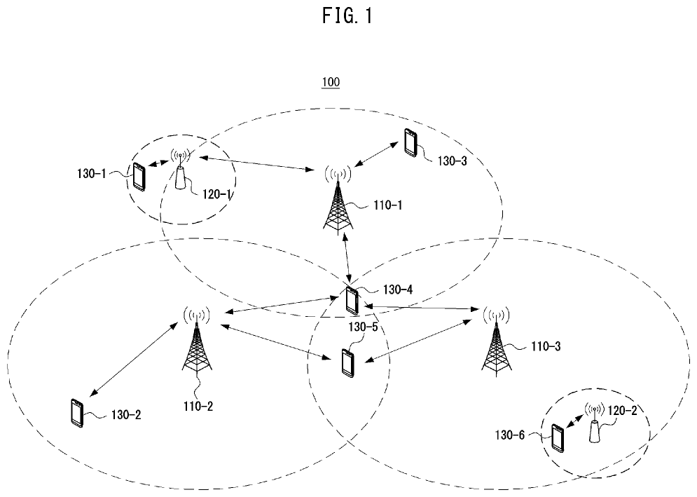

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have a structure below.

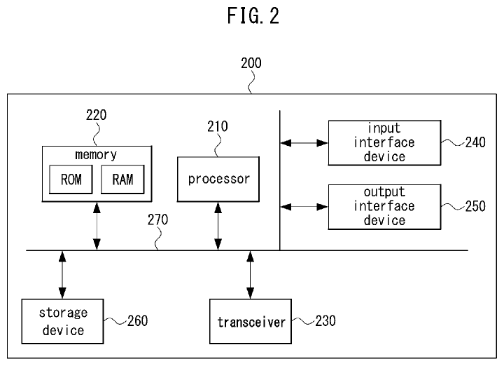

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

The base station and the terminal may perform communication using an omnidirectional beam, a sector beam, or a spot beam. The omnidirectional beam may be formed using an omnidirectional antenna, and the spot beam may be formed using a beamforming antenna.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication system will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a wireless communication technology for supporting improved transmission services may use not only beamforming employing an evolved smart antenna technology and a massive multiple-input multiple-output (MIMO) technology but also various radio frame structures. Also, the wireless communication technology may employ various numerology forms of system transmission standards.

Further, the wireless communication technology may employ a physical uplink shared channel (PUSCH)/physical downlink shared channel (PDSCH) for uplink or downlink data transmission. Also, the wireless communication technology may employ a physical uplink control channel (PUCCH)/physical downlink control channel (PDCCH) for transmitting uplink or downlink control information.

In addition, the wireless communication technology may employ a reference signal, a channel status information (CSI) report, an uplink data buffer status report (BSR) of a user equipment (UE), etc.

According to a recently published mobility report, it is possible to predict that mobile data traffic will grow 60-fold from 2013 to 2024. Also, according to the report, it is possible to predict that the amount of global mobile data traffic will reach 131 billion gigabytes (BGB) per month by 2024 with 74% growth predicted to continue due to multimedia creation and consumption.

Further, according to the report, it is possible to predict that 25% of mobile data traffic will be transmitted through fifth generation (5G) networks. The amount of global mobile data traffic which is predicted to increase as described above may be 1.3 times the total sum of current fourth generation (4G), third generation (3G), and second generation (2G) traffic.

Meanwhile, global mobile data traffic may explosively increase due to mobilizing media and entertainment content. Also, global mobile data traffic may explosively increase with a massive increase in rich user-generated content.

Further, global mobile data traffic may explosively increase with an increase in congested environments of mobile data traffic due to crowding of users. Also, global mobile data traffic may explosively increase due to high-speed mobility traffic. Also, global mobile data traffic may explosively increase due to traffic of connected cloud computing services. Also, global mobile data traffic may explosively increase due to 3D video content (immersive experience) traffic.

Moreover, global mobile data traffic may explosively increase due to connected vehicle service traffic. Also, global mobile data traffic may explosively increase due to augmented reality (AR) service traffic and the like. Each of content characteristics, UE characteristics, or service characteristics may have characteristics of similar traffic groups.

Meanwhile, an evolved standard technology and improvements in traffic scheduling may be necessary for the massive amount of mobile data traffic and to meet advanced 5G requirements. In particular, improvements in traffic scheduling may be necessary to efficiently manage power of a UE. Also, improvements in traffic scheduling may be necessary to efficiently manage various device types in accordance with the processing capabilities of UEs and transmission services for the device types. Also, improvements in traffic scheduling may be necessary to satisfy service quality in accordance with a traffic service type of a UE.

Further, improvements in traffic scheduling may be necessary to fairly distribute resources in consideration of radio conditions and transmission load in a situation in which UEs are highly concentrated. Also, improvements in traffic scheduling may be stabilized in consideration of a state of a UE and may be necessary due to comprehensive consideration of system settings for rapid access and the like.

Moreover, efficient management of a downlink control channel for scheduling may be very important for managing a limited control channel area and limited radio resources in a situation in which the number of UEs in a cell is massively increasing and UEs demanding a service are highly concentrated. Also, a scheduling method in which an advanced technology and procedure are taken into consideration may become important due to the necessity to schedule a massive number of UEs and the resultant necessity for massive control channels. To this end, the scheduling method may be advanced by controlling assignment of radio resources shared among users in time and frequency sections.

Therefore, improvements of a traffic scheduling method may be necessary to set radio resources using an evolved wireless communication technology in accordance with the purpose or type of using a service or a transmission technology. Also, improvements of a traffic scheduling method may be necessary to control radio resources in accordance with a system environment such as a wireless channel state of a UE and the like. Also, improvements of a traffic scheduling method may be necessary to schedule downlink and uplink data in accordance with a state of a wireless channel. Efficient management of a downlink control channel for scheduling may be necessary to signal scheduling information in an environment in which UEs are highly concentrated.

Accordingly, the present application may provide a technology that may be advanced to satisfy various services and requirements in a wireless communication system and intended to efficiently manage radio resources in a complex wireless communication environment. Also, the present application may provide a technology that may set radio resources in accordance with a service purpose or type of a wireless communication and transmission technology and control radio resources in accordance with a service type or a channel state. Also, the present application may provide a procedure for signaling controlled information. In addition, the present application may provide a scheduling method and procedure in accordance with a state of a wireless channel.

For example, to efficiently manage radio resources in a communication system of an environment in which UEs are highly concentrated, the present application may provide a group scheduling method for one or more UEs. Also, according to the present application, a base station may make resource groups in accordance with various pieces of information, such as a channel state, the presence or absence of the same or similar beam area, a channel state of a neighboring beam, a type of data size, a state of an uplink buffer, a state of a UE, etc., to perform MIMO and the like on a group including one or more UEs. According to the present application, a base station may control radio resources and schedule an uplink and a downlink by activating grouped resources.

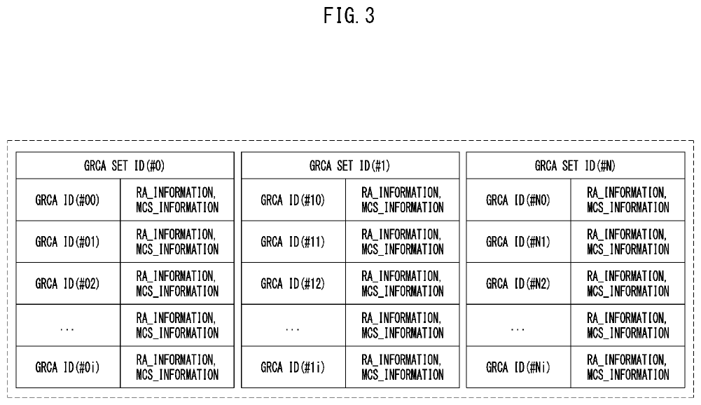

FIG. 3 is a conceptual diagram showing a first example embodiment of group resource control (GRC) configuration information.

Referring to FIG. 3, GRC configuration information may include N+1 group resource control assignment (GRCA) sets. Here, N may be a positive integer. Also, each of the GRCA sets may be distinguished by a GRCA set identifier (ID). Here, the GRCA set ID may be, for example, #0 to #N.

Each of the GRCA sets may include GRCA information. As an example, GRCA set #0 may include i+1 pieces of GRCA information. Each piece of the GRCA information may be distinguished by a GRCA ID. Here, the GRCA ID may be, for example, #00 to #0i. Here, i may be a positive integer.

As another example, GRCA set #1 may include j+1 pieces of GRCA information. Each piece of the GRCA information may be distinguished by a GRCA ID. Here, the GRCA ID may be, for example, #10 to #1j. Here, j may be a positive integer.

As another example, GRCA set #N may include k+1 pieces of GRCA information.

Each piece of the GRCA information may be distinguished by a GRCA ID. Here, the GRCA ID may be, for example, #N0 to #Nk. Here, k may be a positive integer.

Each of the GRCA information may include corresponding group scheduling resource (GSR) information. The GSR information may include at least one of resource allocation (RA) information (i.e., RA information) of the time and frequency domains, modulation and coding scheme (MCS) information (i.e., MCS information) necessary for scheduling, and resource mapping information.

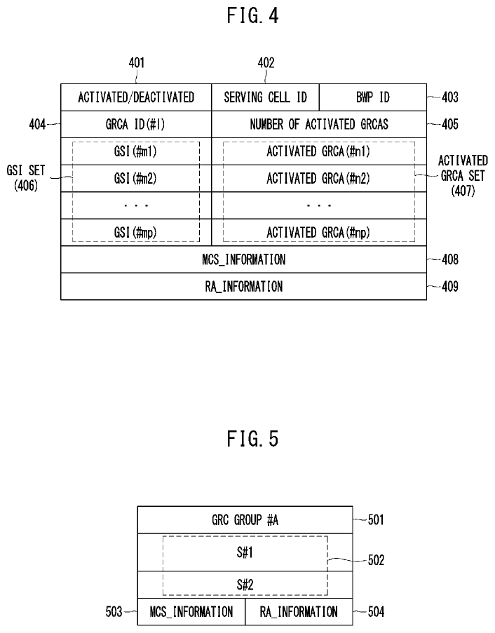

FIG. 4 is a conceptual diagram showing a first example embodiment of GRCA activation control information.

Referring to FIG. 4, GRCA activation control information may include activation or deactivation indication information 401, serving cell ID information 402, bandwidth part (BWP) ID information 403, GRCA set ID information 404, activated GRCA number information 405, activated group scheduling indicator (GSI) set information 406, activated GRCA set information 407, and GSR information. Here, the GSR information may include MCS information 408, RA information 409, etc. necessary for scheduling.

The activation or deactivation indication information 401 may be information representing whether to activate or deactivate a GRCA set identified by a GRCA set ID. The serving cell ID information 402 may be information for identifying a serving cell, that is, indicating the serving cell, when a base station runs multiple cells. The BWP ID information 403 may be information for identifying a BWP used when the serving cell uses one or more BWPs.

The GRCA set ID information 404 may be information for identifying the GRCA set included in the GRCA activation control information. For example, the GRCA set ID may be #1, and 1 may be a positive integer. The activated GRCA number information 405 may be information representing the number of activated GRCAs included in the GRCA activation control information. The number of activated GRCAs may be, for example, p, and p may be a positive integer.

The activated GSI set information 406 may be information representing a set of activated GSIs each indicating the activated GRCAs. For example, there may be p activated GSIs, and the IDs may be #m1 to #mp. The activated GRCA set information 407 may be information representing a set of activated GRCAs. For example, there may be p activated GRCAs, and the IDs may be #n1 to #np.

Accordingly, activated GSI #m1 may indicate activated GRCA #n1, activated GSI #m2 may indicate activated GRCA #n2, and activated GSI #mp may indicate activated GRCA #np. The MCS information 408 may be information representing an MCS necessary for scheduling. The RA information 409 may be information representing RA of the time and frequency domains.

FIG. 5 is a conceptual diagram showing a first example embodiment of group scheduling information.

Referring to FIG. 5, group scheduling information may include GRC group (i.e., UE group) ID information 501, activated GSI list information 502, and GSR information. The GSR information may include MCS information 503 and RA information 504 necessary for scheduling. The GRC group ID information 501 may be information that allows identification of a GRC group which is a target of group scheduling.

For example, a GRC group may be #A. The activated GSI list information 502 may be information representing a list of activated GSIs. For example, the activated GSI list may include S #1 and S #2. S #1 and S #2 may be IDs of activated GSIs. The MCS information 503 may be information representing an MCS necessary for scheduling. The RA information 504 may be information representing RA of the time and frequency domains.

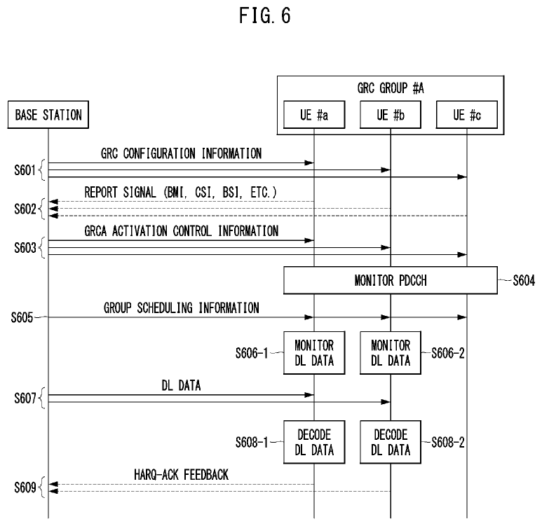

FIG. 6 is a sequence diagram illustrating a first example embodiment of a group scheduling method in a communication system.

Referring to FIG. 6, in the group scheduling method, a base station may generate at least one piece of GRCA information. The base station may assign a GRCA ID for distinguishing each piece of GRCA information. Here, the GRCA information may include GSR information. The GSR information may include at least one of MCS information necessary for scheduling, RA information of the time and frequency domains, and resource mapping information.

Then, the base station may make GRCA sets of pieces of GRCA information. The base station may assign GRCA set IDs for distinguishing the made GRCA sets to the GRCA sets. For at least one GRC group (e.g., GRC group #A), the base station may generate GRC configuration information including at least one GRCA set.

Accordingly, the base station may transmit the GRC configuration information to UE #a, UE #b, and UE #c included in GRC group #A (S601). In this case, the base station may transmit the GRC configuration information to UE #a, UE #b, and UE #c through a radio resource control (RRC) configuration message. Then, UE #a, UE #b, and UE #c may receive the GRC configuration information from the base station. In this case, the base station may signal the GRC configuration information through the RRC configuration message and provide signaling for addition, modification, or release through the RRC configuration message.

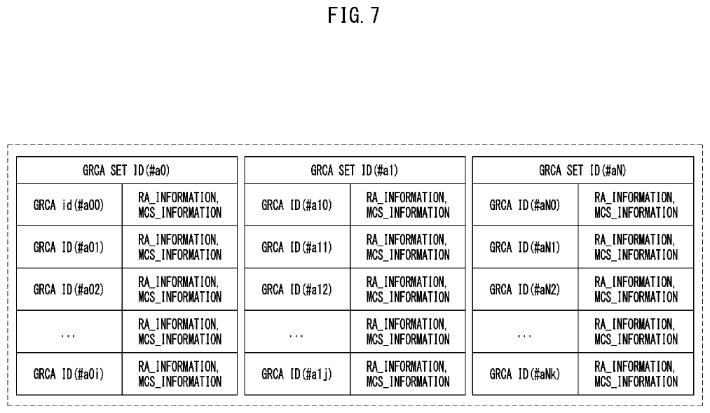

The base station may be one of base stations 110-1, 110-2, 110-3, 120-1, and 120-2 shown in FIG. 1, and each of UE #a, UE #b, and UE #c may be one of UEs 130-1, 130-2, 130-3, 130-4, 130-5, and 130-6 shown in FIG. 1. The base station, UE #a, UE #b, and UE #c may be configured the same as or similar to a communication node 200 shown in FIG. 2. Meanwhile, FIGS. 7 to 9 may show GRC configuration information for each UE.

FIG. 7 is a conceptual diagram showing a first example embodiment of GRC configuration information for a UE.

Referring to FIG. 7, the GRC configuration information may be GRC configuration information for UE #a included in group #A. The GRC configuration information may include N+1 GRCA sets. Here, N may be a positive integer. The GRCA sets may be distinguished by IDs. The IDs of the GRCA sets may be, for example, #a0 to #aN. Each of the GRCA sets may include GRCAs. The GRCAs may be distinguished by IDs.

IDs of i+1 GRCAs included in GRCA set #a0 may be, for example, #a00 to #a0i. Here, i may be a positive integer. IDs of j+1 GRCAs included in GRCA set #a1 may be, for example, #a10 to #a1j. Here, j may be a positive integer. IDs of k+1 GRCAs included in GRCA set #aN may be, for example, #aN0 to #aNk. Here, k may be a positive integer.

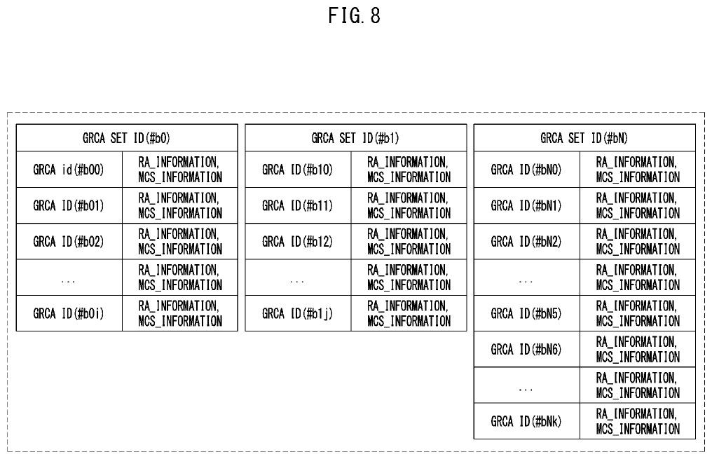

FIG. 8 is a conceptual diagram showing a second example embodiment of GRC configuration information for UE.

Referring to FIG. 8, the GRC configuration information may be GRC configuration information for UE #b included in group #A. The GRC configuration information may include N+1 GRCA sets. Here, N may be a positive integer. The GRCA sets may be distinguished by IDs. The IDs of the GRCA sets may be, for example, #b0 to #bN. Each of the GRCA sets may include GRCAs.

The GRCAs may be distinguished by IDs. IDs of i+1 GRCAs included in GRCA set #b0 may be, for example, #b00 to #b0i. Here, i may be a positive integer. IDs of j+1 GRCAs included in GRCA set #b1 may be, for example, #b10 to #b1j. Here, j may be a positive integer. IDs of k+1 GRCAs included in GRCA set #bN may be, for example, #bN0 to #bNk. Here, k may be a positive integer.

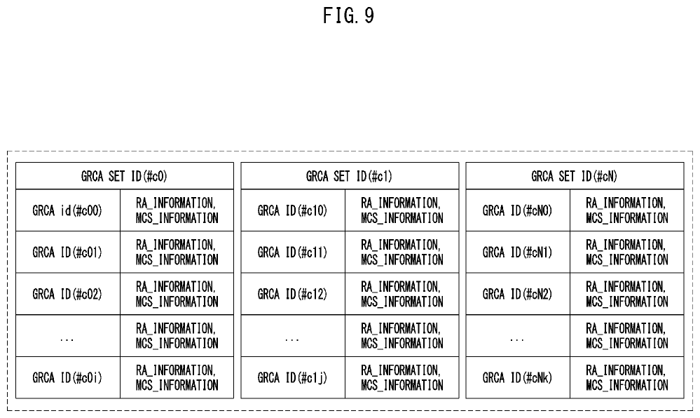

FIG. 9 is a conceptual diagram showing a third example embodiment of GRC configuration information for UE.

Referring to FIG. 9, the GRC configuration information may be GRC configuration information for UE #c included in group #A. The GRC configuration information may include N+1 GRCA sets. Here, N may be a positive integer. The GRCA sets may be distinguished by IDs. The IDs of the GRCA sets may be, for example, #c0 to #cN. Each of the GRCA sets may include GRCAs.

The GRCAs may be distinguished by IDs. IDs of i+1 GRCAs included in GRCA set #c0 may be, for example, #c00 to #c0i. Here, i may be a positive integer. IDs of j+1 GRCAs included in GRCA set #c1 may be, for example, #c10 to #c1j. Here, j may be a positive integer. IDs of k+1 GRCAs included in GRCA set #cN may be, for example, #cN0 to #cNk. Here, k may be a positive integer.

Referring back to FIG. 6, each of UE #a, UE #b, and UE #c may transmit a report signal to the base station (S602). Then, the base station may receive the report signals from UE #a, UE #b, and UE #c. The report signals may include at least one of beam measurement information (BMI), channel state information (CSI), and data buffer state information (BSI).

Meanwhile, for each UE, the base station may generate, using the GRC configuration information provided to UE #a, UE #b, and UE #c, GRCA activation control information which includes activation or deactivation information of a specific GRCA set, information on an activated GRCA set of at least one activated GRCA selected from an activated specific GRCA set, and information on a GSI set of at least one GSI.

The base station may generate GRCA activation control information for each of UE #a, UE #b, and UE #c including activation or deactivation control information for a specific GRCA set from GRC configuration information which is set for group scheduling in accordance with surroundings of the UE, such as a wireless channel state, a movement state, a beam selection state, etc., on the basis of the report signals received from the UE. Then, the base station may transmit the GRCA activation control information generated for each UE to the UE (S603).

In other words, the base station may transmit the GRCA activation control information for UE #a shown in FIG. 7 to UE #a included in GRC group #A. Also, the base station may transmit the GRCA activation control information for UE #b shown in FIG. 8 to UE #b included in GRC group #A. Further, the base station may transmit the GRCA activation control information for UE #c shown in FIG. 9 to UE #c included in GRC group #A.

The base station may transmit the corresponding GRCA activation control information to UE #a, UE #b, and UE #c through GRCA activation control signaling of a media access control (MAC) message or an RRC configuration message. Accordingly, UE #a, UE #b, and UE #c may receive the corresponding GRCA activation control information from the base station.

Here, the base station may designate a specific GRCA set which is set in the GRC configuration information so that the designated specific GRCA set includes one or more activated GRCAs in an activated GRCA list. Also, the base station may identify the activated GRCAs and include a GSI set mapped to one or more GSIs in the GRCA activation control information to provide GRCA information for scheduling.

When the base station runs multiple cells, the base station may include serving cell ID information in the GRCA activation control information. Also, when a serving cell uses one or more BWPs, the base station may separately set the BWPs in the serving cell and include IDs of the set BWPs in the GRCA activation control information.

The base station may include additional GSR information in the GRCA activation control information. The additional GSR information may include at least one of MCS information necessary for scheduling, RA information of the time and frequency domains, and resource mapping information.

Each UE may use the additional GSR information when GSR information is not receivable through the GRC configuration information. Also, each UE may use the additional GSR information to indicate a changed value in the GRC configuration information.

Meanwhile, the base station may give a group scheduling radio network temporary identifier (GS-RNTI) for scrambling a downlink control indicator (DCI) including group scheduling information to UE group #A.

The base station may provide the GS-RNTI to UE #a, UE #b, and UE #c. In this case, the base station may include the GS-RNTI in the GRC configuration information and provide the GS-RNTI to UE #a, UE #b, and UE #c. Also, the base station may assign a group-specific search space (SS) for a physical layer downlink control channel (PDCCH) in which the scrambled DCI is transmitted, using the GS-RNTI.

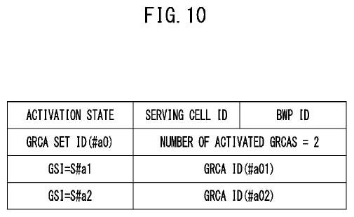

The base station may transmit assignment information of the assigned group-specific SS to UE #a, UE #b, and UE #c. In this case, the base station may include the assignment information of the group-specific SS in the GRC configuration information and provide the assignment information to UE #a, UE #b, and UE #c. Accordingly, UE #a, UE #b, and UE #c may monitor the PDCCH of the assigned group-specific SS (S604). FIGS. 10 to 12 may show GRC configuration assignment information for each UE.

FIG. 10 is a conceptual diagram showing a first example embodiment of GRCA activation control information for a UE.

Referring to FIG. 10, GRCA activation control information may be GRCA activation control information for UE #a included in group #A. GRCA activation control information for UE #a may include activation or deactivation indication information indicating that GRCA set #a0 is activated. Also, the GRCA activation control information for UE #a may include information on activated GRCAs (e.g., GRCA #a01 and GRCA #a02). Also, the GRCA activation control information for UE #a may include information on the number of activated GRCAs (e.g., 2). Also, the GRCA activation control information for UE #a may include information on GSIs indicating the activated GRCAs. For example, a GSI indicating GRCA #a01 may be S #a1, and a GSI indicating activated GRCA #a02 may be S #a2. Also, the GRCA activation control information for UE #a may include a serving cell ID and a BWP ID.

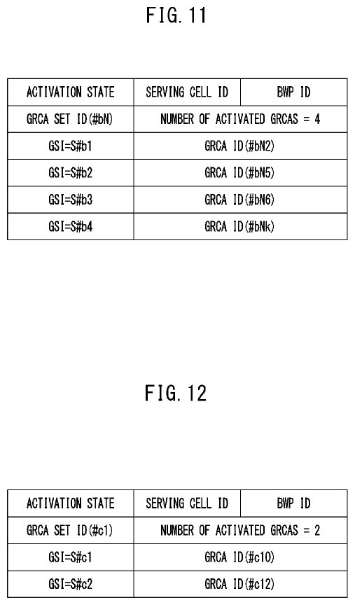

FIG. 11 is a conceptual diagram showing a second example embodiment of GRCA activation control information for a UE.

Referring to FIG. 11, GRCA activation control information may be GRCA activation control information for UE #b included in group #A. The GRCA activation control information for UE #b may include activation or deactivation indication information indicating that GRCA set #bN is activated.

Also, the GRCA activation control information for UE #b may include information on activated GRCAs (e.g., GRCA #bN2, GRCA #bN5, GRCA #bN6, and GRCA #bNk). Also, the GRCA activation control information for UE #b may include information on the number of activated GRCAs (e.g., 4). Also, the GRCA activation control information for UE #b may include information on GSIs indicating the activated GRCAs.

For example, a GSI indicating GRCA #bN2 may be S #b1, a GSI indicating activated GRCA #bN5 may be S #b2, a GSI indicating GRCA #bN6 may be S #b3, and a GSI indicating activated GRCA #bNk may be S #b4. Also, the GRCA activation control information for UE #b may include a serving cell ID and a BWP ID.

FIG. 12 is a conceptual diagram showing a third example embodiment of GRCA activation control information for a UE.

Referring to FIG. 12, GRCA activation control information may be GRCA activation control information for UE #c included in group #A. The GRCA activation control information for UE #c may include activation or deactivation indication information indicating that GRCA set #c1 is activated.

Also, the GRCA activation control information for UE #c may include information on activated GRCAs (e.g., GRCA #c10 and GRCA #c12). Also, the GRCA activation control information for UE #c may include information on the number of activated GRCAs (e.g., 2). Also, the GRCA activation control information for UE #c may include information on GSIs indicating the activated GRCAs.

For example, a GSI indicating GRCA #c10 may be S #c1, and a GSI indicating activated GRCA #c12 may be S #c2. Also, the GRCA activation control information for UE #c may include a serving cell ID and a BWP ID.

Referring back to FIG. 6, the base station may generate downlink scheduling information for each of UE #a, UE #b, and UE #c in accordance with surroundings of the UE, such as a wireless channel state, a movement state, a beam selection state, etc., on the basis of the report signals. Then, the base station may generate downlink group scheduling information including all the downlink scheduling information for the UE and transmit the downlink group scheduling information to UE #a, UE #b, and UE #c (S605).

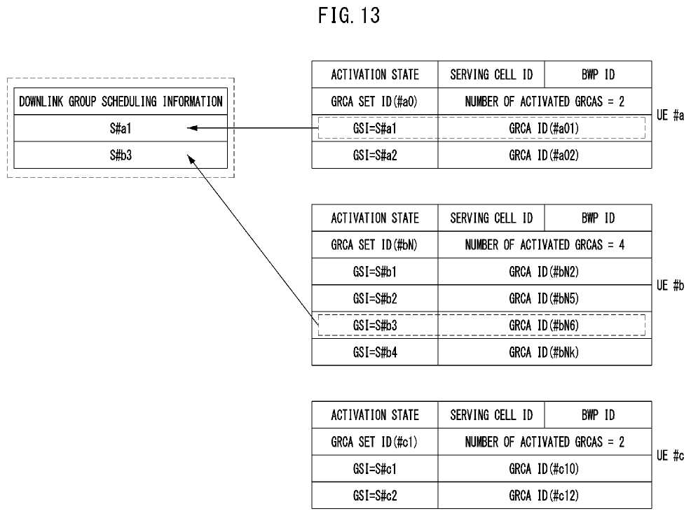

FIG. 13 is a conceptual diagram showing a first example embodiment of a process of generating downlink group scheduling information.

Referring to FIG. 13, in the process of generating group scheduling information, the base station may select GSI S #a1 as the downlink scheduling information for UE #a with reference to the GRCA activation control information for UE #a. Also, the base station may select GSI S #b3 as the downlink scheduling information for UE #b with reference to the GRCA activation control information for UE #b.

Referring back to FIG. 6, the base station may scramble the DCI including the group scheduling information using the GS-RNTI and transmit the scrambled DCI to UE #a, UE #b, and UE #c. Then, UE #a, UE #b, and UE #c may decode the scrambled PDCCH using the GS-RNTI in the group-specific SS, and when the decoding is successful, may receive group scheduling information through the DCI information. Each of UE #a, UE #b, and UE #c may acquire corresponding downlink scheduling information with reference to the GRCA activation control information received from the base station. The downlink scheduling information may be a downlink GSI. In this case, it may be assumed that UE #a may acquire the corresponding downlink scheduling information and UE #b may acquire the corresponding downlink scheduling information. Unlike this, it may be assumed that UE #c may not acquire the corresponding downlink scheduling information.

For example, when the downlink group scheduling information of FIG. 13 is received, UE #a may acquire downlink GSIs S #a1 and S #b3. With reference to the GRCA activation control information of FIG. 10, UE #a may determine that the downlink scheduling indicator S #a1 may be valid and the downlink scheduling indicator S #b3 may be invalid. With reference to the GRCA activation control information of FIG. 10, UE #a may determine that a GRCA indicated by the valid downlink scheduling indicator S #a1 is GRCA #a01. Subsequently, UE #a may check RA information, MCS information, etc. of GRCA #a01 with reference to the GRC configuration information of FIG. 7.

When the downlink group scheduling information of FIG. 13 is received, UE #b may likewise acquire downlink GSIs S #a1 and S #b3. With reference to the GRCA activation control information of FIG. 11, UE #b may determine that the downlink scheduling indicator S #a1 may be invalid and the downlink scheduling indicator S #b3 may be valid. With reference to the GRCA activation control information of FIG. 11, UE #b may determine that a GRCA indicated by the valid downlink scheduling indicator S #b3 is GRCA #bN6. Subsequently, UE #b may check RA information, MCS information, etc. of GRCA #bN6 with reference to the GRC configuration information of FIG. 8.

Meanwhile, the base station may include additional GSR information in group scheduling information. The additional GSR information may include at least one of MCS information necessary for scheduling, RA information of the time and frequency domains, and resource mapping information. Each UE may use the additional GSR information when GSR information is not receivable through the GRC configuration information. Also, each UE may use the additional GSR information to indicate a changed value in the GRC configuration information.

Meanwhile, each of UE #a and UE #b may monitor downlink data on the basis of the RA information, the MCS information, etc. acquired from the corresponding downlink scheduling information (S606-1 and S606-2). The base station may transmit downlink data on the basis of the corresponding downlink scheduling information (S607). Then, each of UE #a and UE #b may receive the downlink data on the basis of the corresponding downlink scheduling information. Each of UE #a and UE #b may acquire the downlink data by decoding the received downlink data (S608-1 and S608-2). When it is not possible to acquire downlink data by decoding the received downlink data, each of UE #a and UE #b may transmit a hybrid automatic repeat and request acknowledgement (HARQ-ACK) feedback signal to the base station (S609). The base station may receive the HARQ-ACK feedback signal from each of UE #a and UE #b.

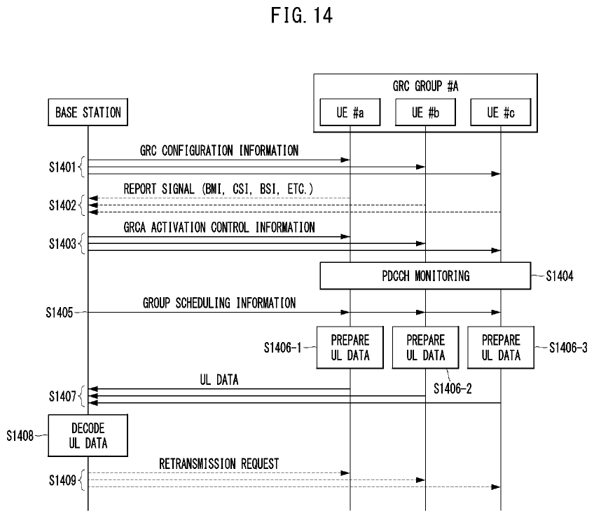

FIG. 14 is a sequence diagram illustrating a second example embodiment of a group scheduling method in a communication system.

Referring to FIG. 14, in the group scheduling method, a base station may generate one or more GRCAs. The base station may assign GRCA IDs for distinguishing the GRCAs from each other. Here, the GRCAs may include GSR information. The GSR information may include at least one of MCS information necessary for scheduling, RA information of the time and frequency domains, and resource mapping information. Subsequently, the base station may make GRCA sets of GRCAs. The base station may assign GRCA set IDs for distinguishing the made GRCA sets. For at least one GRC group (e.g., GRC group #A), the base station may generate GRC configuration information including at least one GRCA set.

Accordingly, the base station may transmit the GRC configuration information to UE #a, UE #b, and UE #c included in GRC group #A (S1401). In this case, the base station may transmit the GRC configuration information to UE #a, UE #b, and UE #c through an RRC configuration message. Then, UE #a, UE #b, and UE #c may receive the GRC configuration information from the base station. In this case, the base station may signal the GRC configuration information through an RRC control message and provide signaling for addition, modification, or release through an RRC control message. The base station may be one of the base stations 110-1, 110-2, 110-3, 120-1, and 120-2 shown in FIG. 1, and each of UE #a, UE #b, and UE #c may be one of the UEs 130-1, 130-2, 130-3, 130-4, 130-5, and 130-6 shown in FIG. 1. The base station, UE #a, UE #b, and UE #c may be configured the same as or similar to the communication node 200 shown in FIG. 2. Meanwhile, FIGS. 7 to 9 may show GRC configuration information for each UE.

Meanwhile, UE #a, UE #b, and UE #c may transmit report signals to the base station (S1402). Then, the base station may receive the report signals from UE #a, UE #b, and UE #c. The report signals may include at least one of BMI, CSI, and data BSI.

Meanwhile, for each UE, the base station may generate, using the GRC configuration information provided to UE #a, UE #b, and UE #c, GRCA activation control information which includes activation or deactivation information of a specific GRCA set, information on an activated GRCA set of at least one activated GRCA selected from an activated specific GRCA set, and information on a GSI set of at least one GSI. The base station may generate GRCA activation control information for each of UE #a, UE #b, and UE #c including activation or deactivation control information for a specific GRCA set from GRC configuration information which is set for group scheduling in accordance with surroundings of the UE such as a wireless channel state, a movement state, a beam selection state, etc.

Then, the base station may transmit the GRCA activation control information generated for each UE to the UE (S1403). In other words, the base station may transmit the GRCA activation control information for UE #a to UE #a included in GRC group #A. Also, the base station may transmit the GRCA activation control information for UE #b to UE #b included in GRC group #A. Further, the base station may transmit the GRCA activation control information for UE #c to UE #c included in GRC group #A. In this case, the base station may transmit the corresponding GRCA activation control information to UE #a, UE #b, and UE #c through GRCA activation control signaling of an MAC message or an RRC configuration message. Accordingly, UE #a, UE #b, and UE #c may receive the corresponding GRCA activation control information from the base station.

Here, the base station may designate a specific GRCA set which is set in the GRC configuration information so that the designated specific GRCA set includes one or more activated GRCAs in an activated GRCA list. Also, the base station may identify the activated GRCAs and include a GSI set mapped to one or more GSIs in the GRCA activation control information to provide GRCA information for scheduling. When the base station runs multiple cells, the base station may include serving cell ID information in the GRCA activation control information. Also, when a serving cell uses one or more BWPs, the base station may separately set the BWPs in the serving cell and include IDs of the set BWPs in the GRCA activation control information.

The base station may include additional GSR information in the GRCA activation control information. The additional GSR information may include at least one of MCS information necessary for scheduling, RA information of the time and frequency domains, and resource mapping information. Each UE may use the additional GSR information when GSR information is not receivable through the GRC configuration information. Also, each UE may use the additional GSR information to indicate a changed value in the GRC configuration information.

Meanwhile, the base station may give a GS-RNTI for scrambling a DCI including group scheduling information to UE group #A. The base station may provide the GS-RNTI to UE #a, UE #b, and UE #c. In this case, the base station may include the GS-RNTI in the GRC configuration information and provide the GS-RNTI to UE #a, UE #b, and UE #c. Also, the base station may assign a group-specific SS for a PDCCH in which the scrambled DCI is transmitted, using the GS-RNTI.

The base station may transmit assignment information of the assigned group-specific SS to UE #a, UE #b, and UE #c. In this case, the base station may include the assignment information of the group-specific SS in the GRC configuration information and provide the assignment information to UE #a, UE #b, and UE #c. Accordingly, UE #a, UE #b, and UE #c may monitor the PDCCH of the assigned group-specific SS (S1404). FIGS. 10 to 12 may show GRCA activation control information for each UE.

Meanwhile, the base station may generate uplink scheduling information for each of UE #a, UE #b, and UE #c in accordance with surroundings of the UE such as a wireless channel state, a movement state, a beam selection state, etc. Then, the base station may generate uplink group scheduling information including all the uplink scheduling information for the UE and transmit the uplink group scheduling information to UE #a, UE #b, and UE #c (S1405).

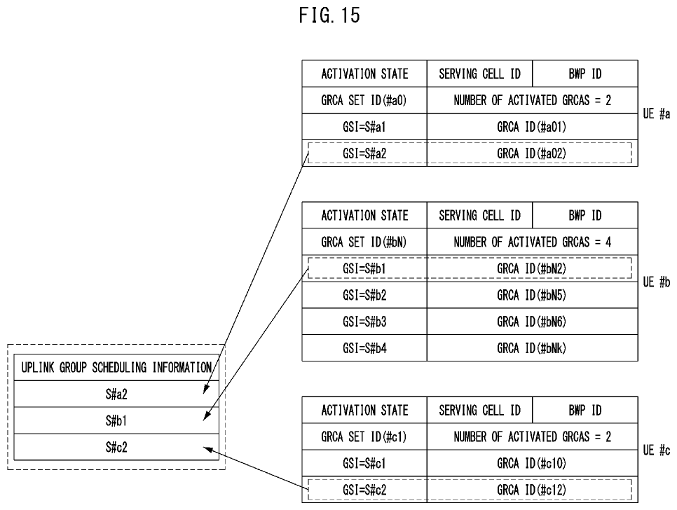

FIG. 15 is a conceptual diagram showing a first example embodiment of a process of generating uplink group scheduling information.

Referring to FIG. 15, in the process of generating group scheduling information, the base station may select GSI S #a2 as the uplink scheduling information for UE #a with reference to the GRCA activation control information for UE #a. Also, the base station may select GSI S #b1 as the uplink scheduling information for UE #b with reference to the GRCA activation control information for UE #b. Further, the base station may select GSI S #c2 as the uplink scheduling information for UE #c with reference to the GRCA activation control information for UE #c.

Referring back to FIG. 14, the base station may scramble the DCI including the group scheduling information using the GS-RNTI and transmit the scrambled DCI to UE #a, UE #b, and UE #c. Then, UE #a, UE #b, and UE #c may decode the scrambled PDCCH using the GS-RNTI in the group-specific SS, and when the decoding is successful, may receive uplink group scheduling information through the DCI information. Each of UE #a, UE #b, and UE #c may acquire corresponding uplink scheduling information with reference to the GRCA activation control information received from the base station. Each piece of the uplink scheduling information may be an uplink GSI.

For example, when the uplink group scheduling information of FIG. 15 is received, UE #a may acquire uplink GSIs S #a2, S #b1, and S #c2. With reference to the GRCA activation control information of FIG. 10, UE #a may determine that the uplink scheduling indicator S #a2 may be valid and the uplink scheduling indicators S #b1 and S #c2 may be invalid. With reference to the GRCA activation control information of FIG. 10, UE #a may determine that a GRCA indicated by the valid uplink scheduling indicator S #a2 is GRCA #a02. Subsequently, UE #a may check RA information, MCS information, etc. of GRCA #a02 with reference to the GRC configuration information of FIG. 7.

When the uplink group scheduling information of FIG. 15 is received, UE #b may likewise acquire uplink GSIs S #a2, S #b1, and S #c2. With reference to the GRCA activation control information of FIG. 11, UE #b may determine that the uplink scheduling indicators S #a2 and S #c2 may be invalid and the uplink scheduling indicator S #b1 is valid. With reference to the GRCA activation control information of FIG. 11, UE #b may determine that a GRCA indicated by the valid uplink scheduling indicator S #b1 is GRCA #bN2. Subsequently, UE #b may check RA information, MCS information, etc. of GRCA #bN2 with reference to the GRC configuration information of FIG. 8.

When the uplink group scheduling information of FIG. 15 is received, UE #c may likewise acquire uplink GSIs S #a2, S #b1, and S #c2. With reference to the GRCA activation control information of FIG. 12, UE #b may determine that the uplink scheduling indicators S #a2 and S #b1 may be invalid and the uplink scheduling indicator S #c2 is valid. With reference to the GRCA activation control information of FIG. 12, UE #c may determine that a GRCA indicated by the valid uplink scheduling indicator S #c2 is GRCA #c12. Subsequently, UE #c may check RA information, MCS information, etc. of GRCA #c12 with reference to the GRC configuration information of FIG. 9.

Meanwhile, the base station may include additional GSR information in group scheduling information. The additional GSR information may include at least one of MCS information necessary for scheduling, RA information of the time and frequency domains, and resource mapping information. Each UE may use the additional GSR information when GSR information is not receivable through the GRC configuration information. Also, each UE may use the additional GSR information to indicate a changed value in the GRC configuration information.

Meanwhile, each of UE #a, UE #b, and UE #c may prepare uplink data to be transmitted through an uplink (S1406-1, S1406-2, and S1406-3). In this case, UE #a, UE #b, and UE #c may transmit the uplink data to the base station on the basis of the uplink scheduling information corresponding to each of UE #a, UE #b, and UE #c (S1407). Then, the base station may receive the uplink data on the basis of the uplink scheduling information corresponding to each UE from UE #a, UE #b, and UE #c.

The base station may acquire necessary uplink data after decoding the received uplink data (S1408). When it is not possible to acquire uplink data by decoding the received uplink data, the base station may transmit a retransmission request signal to UE #a, UE #b, and UE #c to request retransmission of the uplink data (S1409). UE #a, UE #b, and UE #c may receive the retransmission request signal from the base station and retransmit the uplink data to the base station.

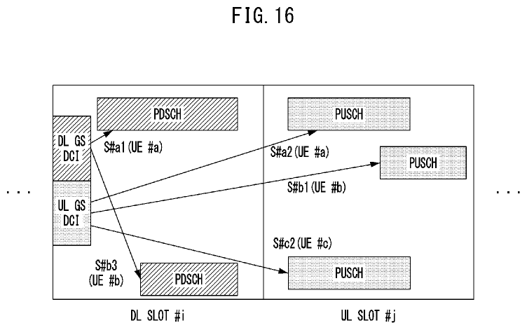

FIG. 16 is a conceptual diagram showing a first example embodiment of a process in which a UE receives group scheduling information and transmits and receives data.

Referring to FIG. 16, UE #a may receive a PDSCH in slot #i with reference to GSR information of GRCA #a1 indicated by GSI S #a1 of a DCI including downlink group scheduling information (i.e., a DL GS DCI). Also, UE #b may receive a PDSCH in slot #i with reference to GSR information of GRCA #bN6 indicated by GSI S #b3 of a DCI including downlink group scheduling information (i.e., a DL GS DCI).

Meanwhile, UE #a may transmit a PUSCH in slot #j with reference to GSR information of GRCA #a1 indicated by GSI S #a2 of a DCI including uplink group scheduling information (i.e., a UL GS DCI). Also, UE #b may transmit a PUSCH in slot #j with reference to GSR information of GRCA #bN2 indicated by GSI S #b1 of a DCI including uplink group scheduling information (i.e., a UL GS DCI). Further, UE #c may transmit a PUSCH in slot #j with reference to GSR information of GRCA #c12 indicated by GSI S #c2 of a DCI including uplink group scheduling information (i.e., a UL GS DCI).

In the group scheduling and resource control method and procedure of the present specification, a communication system can support a group including one or more UEs with an improved data transmission service. To this end, the base station can perform RRC configuration for GRC on a UE. Also, the base station can activate resources for group scheduling by signaling control elements as necessary using set resource control information. Further, the base station can select resources to be scheduled from among activated resources provided to at least one UE in a group and perform downlink or uplink group scheduling through a DCI.

According to the present application, in a wireless communication system of an environment in which UEs are highly concentrated, a base station can make resource groups of radio resources for a UE group of one or more UEs in various ways. Also, according to the present application, it is possible to activate or deactivate resources in a resource group in accordance with a wireless channel state of a UE in a UE group or movement of the UE.

Further, according to the present application, a base station can provide group scheduling to UEs in a UE group for uplink or downlink scheduling in accordance with a wireless channel state or various other types of information. Also, according to the present application, a base station can provide scheduling information to UEs using one DCI. Accordingly, radio resources required for transmitting control information can be reduced, and thus system performance can be improved.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An operating method of a base station in a communication system, the operating method comprising:
providing group resource control (GRC) configuration information including at least one piece of group resource control assignment (GRCA) set information including at least one piece of GRCA information to at least one piece of user equipment (UE) belonging to a UE group;
providing GRCA activation control information including one or more pieces of activated GRCA information selected from a GRCA set and one or more pieces of group scheduling indicator (GSI) information indicating the selected one or more pieces of activated GRCA information to the at least one UE; and
providing group scheduling information including at least one piece of GSI information selected from the one or more pieces of GSI information to the at least one UE.

2. The operating method of claim 1, wherein the providing of the GRC configuration information to the at least one UE belonging to the UE group comprises:
generating the at least one piece of GRCA information including group scheduling resource (GSR) information;
generating the at least one piece of GRCA set information including the at least one piece of GRCA information;
generating the GRC configuration information including the at least one piece of GRCA set information; and
providing the GRC configuration information to the at least one UE belonging to the UE group,
wherein the GSR information includes at least one of modulation and coding scheme (MCS) information necessary for scheduling, resource assignment information of time and frequency domains, and resource mapping information.

3. The operating method of claim 1, further comprising receiving a report signal from the at least one UE,
wherein the one or more pieces of activated GRCA information selected from the GRCA set are formed on the basis of the report signal, or the at least one piece of GSI information selected from the one or more pieces of GSI information is formed on the basis of the report signal, and
the report signal includes at least one of beam measurement information (BMI), channel state information (CSI), and data buffer state information (BSI).

4. The operating method of claim 1, wherein the providing of the GRCA activation control information to the at least one UE comprises:
activating any one GRCA set in the GRC configuration information;
generating the selected one or more pieces of activated GRCA information from the activated GRCA set;
generating the GRCA activation control information including the selected one or more pieces of activated GRCA information and the one or more pieces of GSI information indicating the selected one or more pieces of activated GRCA information; and
providing the GRCA activation control information to the at least one UE belonging to the UE group.

5. The operating method of claim 1, further comprising giving a group scheduling radio network temporary identifier (GS-RNTI) to the UE group,
wherein the GRC configuration information including the GS-RNTI is transmitted to the at least one UE, and the group scheduling information is transmitted to the at least one UE through control information which is scrambled using the GS-RNTI.

6. The operating method of claim 1, wherein the providing of the group scheduling information to the at least one UE comprises:
selecting the at least one piece of GSI information from the one or more pieces of GSI information;
generating the group scheduling information including the selected at least one piece of GSI information; and
providing the generated group scheduling information to the at least one UE.

7. The operating method of claim 1, wherein the group scheduling information is downlink group scheduling information, and
the operating method further comprises:
generating downlink data;
transmitting the downlink data to the at least one UE in accordance with the downlink group scheduling information; and
receiving hybrid automatic repeat and request acknowledgement (HARQ-ACK) feedback for the downlink data.

8. The operating method of claim 1, wherein the group scheduling information is uplink group scheduling information, and
the operating method further comprises receiving uplink data from the at least one UE in accordance with the group scheduling information.

9. An operating method of a user equipment (UE) in a communication system, the operating method comprising:
receiving group resource control (GRC) configuration information including at least one piece of group resource control assignment (GRCA) set information including at least one piece of GRCA information from a base station;
receiving GRCA activation control information including one or more pieces of activated GRCA information selected from a GRCA set and one or more pieces of group scheduling indicator (GSI) information indicating the selected one or more pieces of activated GRCA information from the base station; and
receiving group scheduling information including any one piece of GSI information selected from the one or more pieces of GSI information from the base station.

10. The operating method of claim 9, wherein the GRCA information includes group scheduling resource (GSR) information,
wherein the GSR information includes at least one of modulation and coding scheme (MCS) information necessary for scheduling, resource assignment information of time and frequency domains, and resource mapping information.

11. The operating method of claim 9, wherein the GRCA activation control information received from the base station includes at least one of activation or deactivation indication information, serving cell identifier (ID) information, bandwidth part (BWP) ID information, GRCA set ID information, activated GRCA number information, and group scheduling resource (GSR) information.

12. The operating method of claim 9, wherein the GRC configuration information includes a group scheduling radio network temporary identifier (GS-RNTI) for a UE group, and
wherein the group scheduling information is received through control information which is scrambled using the GS-RNTI.

13. The operating method of claim 9, further comprising:
acquiring any one piece of GSI information from the group scheduling information;
specifying GSI information corresponding to the UE in the acquired GSI information with reference to the GRCA activation control information; and
acquiring GRCA information corresponding to the UE in accordance with the specified GSI information with reference to the GRC configuration information.

14. The operating method of claim 13, further comprising:
checking group scheduling resource (GSR) information of the GRCA information corresponding to the UE; and
when the group scheduling information is downlink group scheduling information, receiving downlink data on the basis of the checked GSR information.

15. The operating method of claim 13, further comprising:
checking group scheduling resource (GSR) information of the GRCA information corresponding to the UE;
when the group scheduling information is uplink group scheduling information, preparing uplink data; and
transmitting the prepared uplink data to the base station on the basis of the checked GSR information.

16. The operating method of claim 9, further comprising transmitting a report signal including at least one of beam measurement information (BMI), channel state information (CSI), and data buffer state information (BSI) to the base station,
wherein the one or more pieces of activated GRCA information selected from the GRCA set are generated on the basis of the report signal, or
the one piece of GSI information selected from the one or more pieces of GSI information is generated on the basis of the report signal.

17. A user equipment (UE) including a processor, wherein the processor operates to cause the UE to perform operations of:
receiving group resource control (GRC) configuration information including at least one piece of group resource control assignment (GRCA) set information including at least one piece of GRCA information from a base station;
receiving GRCA activation control information including one or more pieces of activated GRCA information selected from a GRCA set and one or more pieces of group scheduling indicator (GSI) information indicating the selected one or more pieces of activated GRCA information from the base station; and
receiving group scheduling information including any one piece of GSI information selected from the one or more pieces of GSI information from the base station.

18. The UE of claim 17, wherein the GRC configuration information includes a group scheduling radio network temporary identifier (GS-RNTI) for a UE group, and
wherein the group scheduling information is received through control information which is scrambled using the GS-RNTI.

19. The UE of claim 17, wherein the processor operates to cause the UE to further perform operations of:
acquiring any one piece of GSI information from the group scheduling information;
specifying GSI information corresponding to the UE in the acquired GSI information with reference to the GRCA activation control information; and
acquiring GRCA information corresponding to the UE in accordance with the specified GSI information with reference to the GRC configuration information.

20. The UE of claim 19, wherein the processor operates to cause the UE to further perform operations of:
checking group scheduling resource (GSR) information of the GRCA information corresponding to the UE; and
when the group scheduling information is downlink group scheduling information, receiving downlink data on the basis of the checked GSR information.
